(19) United States
(12) Patent Application Publication
(10) Pub. No.: US 2013/0186867 A1
(43) Pub. Date: Jul. 25, 2013

(54) Spot Welding Clamp and A Spot Welding Process

(71) Applicants: Johnny WEI, Dongguan City (CN); Hellen ZHOU, Dongguan City (CN)

(72) Inventors: Johnny WEI, Dongguan City (CN); Hellen ZHOU, Dongguan City (CN)

(21) Appl. No.: 13/355,507

(22) Filed: Jan. 21, 2012

(51) Int. Cl. B23K 11/11

(52) U.S. Cl. 219/86.1

(57) ABSTRACT

The invention belongs to the technical field of welding, and in particular relates to a spot welding clamp which avoids rosin joint, false welding and fire blasting and is used in spot welding process with high efficiency. The spot welding clamp comprises a clamp body, an electric core holding area and a fuse holding area, wherein the electric core holding area and the fuse holding area are arranged on the clamp body. A clearance is arranged between the electric core holding area and the fuse holding area. Compared with the prior art, the spot welding clamp can well position a fuse and a metal strip and adjust the height of a welding pin, thus improving spot welding quality, lowering welding defect rate, improving productivity and reducing cost. In addition, the invention also discloses a spot welding process using the spot welding clamp.

### TECHNICAL FIELD

The invention belongs to the technical field of welding, and in particular relates to a spot welding clamp which avoids rosin joint, false welding and fire blasting and is used for efficient spot welding process.

### BACKGROUND OF THE INVENTION

With the continuous development of electronic equipment, the battery, as the power supply of electronic equipment, also enjoys a rapid development and is designed to be thinner and lighter following the miniaturization of the electronic equipment.

A battery commonly comprises an electric core, a protection board arranged at the front end of the electric core and other relevant structural components such as a front cover, a rear cover and a shell. The fuse is generally arranged on the protection board. When the temperature of the battery reaches to certain extent, the fuse can cut off the circuit to avoid the explosion of the battery. The connection between the electric core and the fuse is realized by the spot welding. In order to reduce the thickness of the electric core, the Ni/Al cladding strip is generally welded on the copper foot of the fuse through spot welding, with welding tension required to be more than or equal to 10N.

In the existing spot welding, the fuse and the Ni/Al cladding strip are placed on the spot welding clamp, wherein the copper foot of the fuse is arranged above the Ni/Al cladding strip and then the copper pin of the spot welding machine are in direct contact and undergo spot welding. However, the projection point of the copper foot of the fuse is arranged upwards and the Ni/Al cladding strip is provided with a double-layer structure, which leads to relatively large difficulty in spot welding and easily causes rosin joint or false welding, or even insufficient tension, thus producing a large amount of defective products and affecting product quality. Moreover, professionals need to find out rosin joint or false welding for repair welding, which is time and labor-consuming and affects productivity.

In addition, the increase of relevant parameters of spot welding equipment such as energy output can avoid rosin joint or false welding, but also can result in over welding, fire blasting, penetration caused by welding, etc. Fire blasting is particularly serious, which can cause the scrapping of the fuse, low material utilization and low rate of high-quality product. Fire blasting causes the scattering of spark, which possibly damages adjacent devices or even hurts operators.

In this case, a spot welding clamp is necessarily provided, which can avoid rosin joint, false welding and fire blasting and is used in spot welding process with relatively high efficiency.

### SUMMARY OF THE INVENTION

One of the aims of the invention is to provide a spot welding clamp which can avoid rosin joint, false welding and fire blasting and is used in spot welding process with relatively high efficiency.

In order to realize the aim, the technical proposal adopted by the invention is as follows:

The invention discloses a spot welding clamp, which comprises a clamp body, an electric core holding area and a fuse holding area, wherein the electric core holding area and the fuse holding area are arranged on the clamp body. A clearance is arranged between the electric core holding area and the fuse holding area.

An improvement of the spot welding clamp of the invention lies in that the electric core holding area and the fuse holding area are arranged vertically.

An improvement of the spot welding clamp of the invention lies in that the electric core holding area has a groove structure.

An improvement of the spot welding clamp of the invention lies in that the fuse holding area has a groove structure.

An improvement of the spot welding clamp of the invention lies in that the adjuster for adjusting the height of the welding pin is arranged on the clamp body.

An improvement of the spot welding clamp of the invention lies in that the tab made of the Ni/Al cladding strip is arranged on the electric core.

Compared with the prior art, the spot welding clamp can well position a fuse and a metal strip and adjust the height of a welding pin, thus improving spot welding quality, lowering welding defect rate, improving productivity and reducing cost.

The other aim of the invention is to provide the spot welding process which includes the following steps:
a) placing a fuse with right side up in the fuse holding area; placing the electric core in the electric core holding area in the way that the tab of the electric core is arranged above a copper foot of the fuse and arranging the copper foot of the fuse above the clearance; and
b) arranging the welding pin of a spot welding machine above the tab of the electric core so as to carry out spot welding.

An improvement of the spot welding clamp of the invention lies in that the adjuster is used for adjusting the height of the welding pin.

An improvement of the spot welding clamp of the invention lies in that the tab of the electric core is made of the Ni/Al cladding strip.

Compared with the prior art, in the spot welding process of the invention, the Ni/Al cladding strip is arranged above the copper foot of the fuse so as to lower the difficulty of spot welding, increase spot welding tension and improve spot welding quality, thus realizing smaller thickness of the electric core; the adjuster can adjust the height of the welding pin; the spot welding process can control the energy output of the spot welding machine, thus improving spot welding quality, avoiding rosin joint, false welding and fire blasting, improving production efficiency and reducing cost. Simultaneously, spot welding is carried out in the clearance, which can reduce spark during welding so as to prevent the spark from damaging other devices or hurting operators.

### BRIEF DESCRIPTION OF THE DRAWINGS

FIG. 1 is the top view of the spot welding of the invention; and

FIG. 2 is the bottom view of the spot welding of the invention.

### DETAILED DESCRIPTION OF THE PREFERRED EMBODIMENTS

The following further gives detailed description of the invention through embodiment and the drawings attached to the description, but the embodiment of the invention is not limited to the embodiment herein.

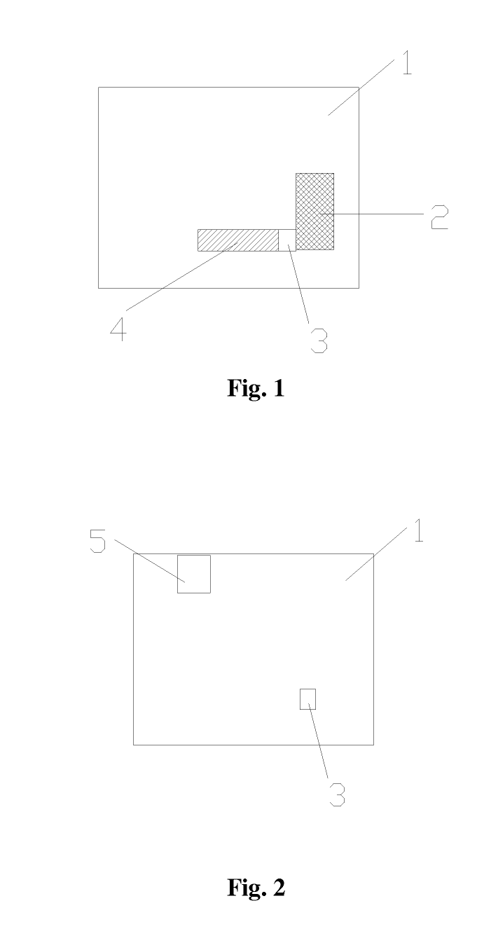

As shown in FIG. 1 and FIG. 2, the invention provides a spot welding clamp which comprises a clamp body 1, an electric core holding area 2 and a fuse holding area 3, wherein the electric core holding area 2 and the fuse holding area 3 are arranged on the clamp body 1. A clearance 4 is arranged between the electric core holding area 2 and the fuse holding area 3. The electric core holding area 2 and the fuse holding area 3 are arranged vertically. The electric core holding area 2 has a groove structure. The fuse holding area 3 has a groove structure. A tab made of a Ni/Al cladding strip is arranged on an electric core.

As shown in FIG. 2, the adjuster 5 used for adjusting the welding pin is arranged on the clamp body 1.

When the clamp is used for carrying out spot welding, the following steps are included:
a) placing a fuse with right side up in the fuse holding area 3 with a groove structure and placing the electric core in the electric core holding area 2 with a groove structure to ensure that the tab of the electric core is arranged above the copper foot of the fuse and arranging the copper foot of the fuse above on the clearance 4, wherein the tab of the electric core is made of the Ni/Al cladding strip; and
b) using the adjuster for adjusting the welding pin to proper height and then placing the welding pin of the spot welding machine above the Ni/Al cladding strip to carry out spot welding.

When in real operation, the energy output percentage of the spot welding machine can be adjusted so as to avoid over welding. A spot welding time counter and an alarm connected with the spot welding time counter can be set beside the welding pin of the spot welding machine. When in use, the maximum spot welding time such as 100 is set. When the spot welding time reaches 100, the alarm gives an alarm so as to remind the operators to grind and level the welding pin so as to avoid the adhesion of the pin.

Compared with the prior art, in the spot welding process of the invention, the Ni/Al cladding strip is arranged above the copper foot of the fuse so as to lower the difficulty of spot welding; the adjuster can adjust the height of the welding pin; the spot welding process can control the energy output of the spot welding machine, thus improving spot welding quality, avoiding rosin joint, false welding and fire blasting, improving production efficiency and reducing cost. Simultaneously, spot welding is carried out in the clearance, which can reduce spark during welding so as to prevent the spark from damaging other devices or hurting operators.

According to the disclosure and guidance of the description, the technicians of the field to which the invention belongs can change and modify the embodiment. Therefore, the invention is not limited to the embodiment disclosed and described above and the change and modification of the invention is also within the protection scope of the claims of the invention. In addition, though some specific terms are used in the description, such terms are used for description and do not limit the invention.

What is claimed is:

1. A spot welding clamp, comprising a clamp body, an electric core holding area and a fuse holding area, wherein the electric core holding area and the fuse holding area are arranged on the clamp body, a clearance is arranged between the electric core holding area and the fuse holding area.

2. The spot welding clamp according to claim 1, wherein the electric core holding area and the fuse holding area are arranged vertically.

3. The spot welding clamp according to claim 1, wherein the electric core holding area has a groove structure.

4. The spot welding clamp according to claim 1, wherein the fuse holding area has a groove structure.

5. The spot welding clamp according to claim 1, wherein an adjuster is arranged on the clamp body for adjusting the height of the welding pin.

6. The spot welding clamp according to claim 1, wherein a tab made of a Ni/Al cladding strip is arranged on an electric core.

7. A spot welding process, comprising the following steps:
a) placing a fuse with right side up in the fuse holding area; placing an electric core in the electric core holding area in the way that the tab of the electric core is arranged above a copper foot of the fuse and arranging a copper foot of the fuse above a clearance; and
b) arranging the welding pin of a spot welding machine above the tab of the electric core so as to carry out spot welding.

8. The spot welding process according to claim 7, wherein the height of the welding pin is adjusted by the adjuster before spot welding.

9. The spot welding process according to claim 7, wherein the tab of the electric core is made of the Ni/Al cladding strip.
